(19) United States
(12) Patent Application Publication
(10) Pub. No.: US 2018/0103670 A1
(43) Pub. Date: Apr. 19, 2018

(54) COMPOSITION, DRINK, METHOD OF PRODUCTION AND USE THEREOF

(71) Applicant: MAMAJAYA S.R.L., Brescia (IT)

(72) Inventor: Claudio RECENTI, Brescia (IT)

(21) Appl. No.: 15/554,990

(22) PCT Filed: Mar. 3, 2016
(86) PCT No.: PCT/IB2016/051204

§ 371 Date: Aug. 31, 2017

(30) Foreign Application Priority Data
Mar. 4, 2015 (IT) BS2015A000031

(51) Int. Cl. A23L 33/105; A23L 2/02; A23L 2/38; A23L 2/60; A23F 5/24

(52) U.S. Cl. CPC A23L 33/105; A23L 2/02; A23L 2/38; A23V 2250/2108; A23F 5/24; A23V 2002/00; A23V 2200/33; A23L 2/60

(57) ABSTRACT

A composition includes green coffee extract and yerba mate extract, and is suitable for mixing or infusing with a base liquid to obtain an edible drink with an energizing and stimulating effect. A drink is made with such a composition.

The present invention relates to an edible natural composition, preferably suitable for the production of drinks.

The increasing pace of life of modern times exposes the population to increasing stress, both mental and physical.

A substantial quantity of products on the market are made with ingredients suitable to moderate one or more aspects related to this type of stress, including Ginseng, Guarana, Taurine, Ginko giogioba. There is a very large variety of such ingredients and various combinations thereof entail different effects depending on the interactions between the ingredients, the quantity or concentration thereof.

Frequently such ingredients are synthetic or are added to compositions or drinks which are not 100% natural. Furthermore, some drinks with added synthetic ingredients, such as beverages with a high concentration of caffeine or taurine, have a flavour differing from the taste of a natural drink.

Therefore, the development of new combinations of ingredients is obtained by careful experimental selection of the ingredients within a wide possibility of choice.

The purpose of the present invention is to make a natural edible composition with beneficial stimulant, antioxidant and energizing effects which overcomes the drawbacks referred to above.

Such purpose is achieved by a composition according to claim 1, by a drink according to claim 8, by a method according to claim 13 and by an edible composition according to claim 17. The dependent claims describe embodiment variants.

The characteristics and advantages of the present invention will be evident from the description below, made by way of a non-limiting example.

The composition according to the present invention comprises green coffee extract and extract of yerba mate.

These two ingredients make it possible to obtain an energizing composition and natural stimulant, without the addition of synthetic substances.

Preferably, moreover, the composition also comprises extract of Andean Maca.

The composition is edible and is suitable to be mixed or infused with a base liquid to obtain an edible drink. For example, the base liquid is water or a natural fruit juice, or any edible liquid, preferably natural.

The term natural is understood to mean that the product includes natural ingredients, or ingredients produced by nature and not by the interaction of man through chemical procedures, such as additives or flavourings derived from chemical substances. Furthermore, processes such as pasteurization, sterilization, freezing, concentration and extraction of substances from natural plants (e.g. herbal extracts) can be applied to a product still ensuring that the product may be considered natural (for example, a pasteurized fruit juice is natural).

Plant extraction (or extract) is a process in which liquid (fluid extracts), solid (dry extracts) or intermediate consistency (soft extracts) products are obtained starting from fresh plant substances or, more commonly dried, using suitable extraction processes; these include the use of suitable solvents and the use of maceration or percolation, or other suitable processes. It is then the degree of removal of the solvent which decides the plant extract consistency (fluid, dry or soft). Depending on the solvent used, plant extracts are classified into aqueous, hydro-alcoholic, alcoholic and ethereal. Regardless of the choice of solvent, its removal down to the required concentration is performed using processes suitable to conserve the active ingredient.

Preferably, the yerba mate extract (or Mate) is a dry Mate extract, preferably comprising at least 8% of Xanthine. Yerba Mate also known by its botanical name Ilex paraguariensis and is a natural product. For example, the dry extract of yerba mate is made from the leaves (leathery) of the plant, preferably collected in the Autumn/Winter period where it is grown in South America. Preferably, the type of drying used is Spray-Drying and, in addition, the solvent used for the realization of the dry extract is water.

Preferably, moreover, the dry yerba mate extract comprises between 60% and 80% by weight of yerba mate extract, preferably with at least 8% by weight of Xanthine. The remaining percentage by weight of dry extract preferably comprises at most 30% of maltodextrin as excipient and the remaining percentage up to 100% of water.

Preferably, moreover, the dry yerba mate extract contains a quantity of caffeine at least 7% by weight.

Preferably, the pH of the dry yerba mate extract is between 4 and 6.

The Andean Maca extract is preferably an aqueous dry extract, comprising for example between 65% and 85% by weight of Lepidium meyenii grass extract. The remaining percentage by weight of dry extract of Andean Maca preferably comprises at most 30% of maltodextrin as excipient and the remaining percentage up to 100% of water. The Andean Maca extract is extracted for example from organic tubers of Lepidum Meyenii and preferably the extraction solvent is hot water.

Preferably, the pH of the Andean Maca dry extract is between 3.5 and 6.

The green coffee extract is preferably a dry hydroalcoholic extract comprising chlorogenic acid preferably in an amount of at least 50% by weight, for example between 50% and 55%. Green coffee is also known by its botanical name Coffea arabica L. Preferably, the extract of green coffee is extracted from the seeds of the coffee plant and the extraction solvent used is a mixture of 70 parts of ethanol and 30 parts of water.

Preferably, the pH of the green coffee dry extract is between 3.5 and 5.5.

Preferably, the dry extracts of yerba mate, Andean Maca and green coffee have a carbohydrate content of between 90% and 95% by weight and a content of fats and proteins less than 1%. Also, preferably such dry extracts have a content of minerals between 3% and 5%.

Preferably, the energy value of each of the dry extracts is less than 2000 kJ/100 g, for example 1711 kJ/100 g, equivalent to about 409 kcal/100 g.

Preferably, moreover, each of the aforementioned dry extracts presents total aflatoxins of less than 4 ppb and heavy metals in amounts below 20 ppm.

Both the green coffee, yerba Mate and Andean Maca are preferably in the form of hygroscopic powder. Subsequently they can be mixed and treated to make the composition.

In one embodiment, the composition further comprises bay extract and/or peppermint extract and/or roasted coffee extract.

In a further embodiment, the composition may also contain sweetening substances.

Preferred sweeteners used in the present invention are sugars and sugar alcohols. For example sucrose, fructose, dextrose, maltose, lactose, fructose, invert sugar, sugar alcohols, including sorbitol, as well as mixtures of these sugars and sugar alcohols. A further preferred sweetener substance, for example contained in one embodiment, is honey, preferably mixed flower honey.

Further sweeteners included in the composition described are for example sweeteners derived from Stevia, sweeteners derived from momordica grosvenorii and sweeteners derived from mogrosides.

In one embodiment the composition is for example made in the form of powder, or of compacted powder, or tablets or bars, or lozenges, or capsules or sachets of powder. Preferably, moreover, the tablets may be chewed or dissolved under the tongue.

In a further embodiment the composition is made in liquid form, for example concentrated.

The present invention also relates to a drink comprising a composition as described in the preceding paragraphs, wherein the composition is mixed or co-infused in an edible base liquid, for example in water.

Preferably, the base liquid comprises at least a natural fruit juice, preferably a natural lemon juice and/or mandarin, and/or orange (for example non-sanguine orange), and/or apple, and/or pomegranate juice. Preferably by the term natural juice, a 100% fruit juice is meant.

In one embodiment, the base liquid comprises at least one fruit juice concentrate, such as a concentrated fruit juice between 10% and 80%, preferably 12% or 50%. Examples of fruit juice concentrate may be concentrated lemon juice, and/or orange (for example non-sanguine orange) and/or tangerine, and/or apple, and/or pomegranate juice.

In one embodiment, the composition in the form of powder or compacted powder, or tablets, or bars or lozenges or capsules or sachets of powder is mixed in the base liquid (for example water) or, in the case of it being in the form of a sachet or capsule, infused into the base liquid.

The preparation method of the beverage then comprises at least the step of mixing or infusing the composition with the ingredients described in the previous paragraphs in an edible base liquid.

In one embodiment, the method also provides for pasteurizing the mixture or the infusion obtained from the step of mixing or infusion of the composition.

Pasteurization is appropriate in order to minimize health risks due to heat-sensitive pathogenic microorganisms, such as bacteria in vegetative form, fungi and yeasts, with minimal alteration of the chemical, physical and organoleptic properties of the drink. Preferably, pasteurisation is carried out by keeping the drink at 60-65° C. for about 30 minutes of time, or at 75-85° C. for a time interval varying from 10 to 20 seconds.

Preferably, the method of making the drink also comprises the step of mixing at least a natural fruit juice, for example a 100% natural fruit juice or a concentrate of fruit juice as described previously. The addition of fruit juice preferably occurs before the pasteurization step.

Innovatively and advantageously, the present invention relates to a composition that thanks to the simultaneous presence of yerba Mate and green coffee entails energizing effects, tonic-stimulant and slimming effects on the individual taking it, naturally, without the addition of synthetic substances.

Advantageously, the presence of Andean Maca, moreover, also adds nutritional, anti-sterility and partially aphrodisiac effects in addition to increasing the tonic-stimulating effect.

In addition, the composition is innovatively used as a drink which may be easily drunk for example after strenuous exercise as an energizing drink or after waking in the morning to face the day. Being a natural beverage, it is suitable to be drunk at any time of the day and has a pleasant taste due to the presence of fruit juices and honey. At appropriate doses, the drink is therefore suitable to be consumed by children as it meets their taste.

In particular, the drink can be used to provide any of the above benefits associated with consumption of yerba mate, Andean Maca and green coffee. It is particularly preferred to use the drink to have an energizing stimulating and antioxidant effect on the individual drinking it. Preferably the beverage is taken orally.

Advantageously, moreover, the drink does not present traces of gluten and thus is suitable to be drunk by individuals suffering from celiac disease.

Additionally, in an advantageous composition it is completely natural and has ingredients such as bay, peppermint and roasted coffee which produce purifying and antiseptic effects (bay leaf and peppermint), as well as other stimulant and slimming effects (roasted coffee).

It is clear that a person skilled in the art may make modifications to the composition or drink or method described above so as to satisfy specific and contingent requirements, all contained within the scope of protection as defined by the following claims.

1. Composition comprising green coffee extract and yerba Mate extract, suitable for being mixed or infused with a basic liquid to obtain an edible drink.

2. Composition according to claim 1 further comprising Andean Maca extract.

3. Composition according to claim 2, wherein the Andean Maca extract is a dry aqueous extract.

4. Composition according to claim 1, wherein the yerba Mate extract is a dry extract of yerba Mate, comprising at least 8% of xanthines.

5. Composition according to any of the previous claims claim 1, wherein the green coffee extract is a hydroalcoholic extract, comprising at least 50% chlorogenic acid.

6. Composition according to claim 1, further comprising bay extract or peppermint extract and/or extract of roasted coffee.

7. Composition according to claim 1 further comprising at least one sweetener chosen from the group comprising honey, mixed flower honey, and/or sucrose, fructose, dextrose, maltose, lactose, fructose, invert sugar, polyols, sorbitol, sweeteners derived from Stevia, sweeteners derived from Momordica grosvenori, sweeteners derived from mogrosides.

8. Drink comprising a composition according to claim 1 mixed or infused into an edible base liquid.

9. Drink according to claim 8, wherein the base liquid comprises at least water.

10. Drink according to claim 8, wherein the base liquid comprises at least one natural fruit juice.

11. Drink according to claim 10, wherein the natural juice is at least one chosen from natural lemon juice, natural mandarin juice, natural orange juice, non-sanguine orange juice, natural apple juice, natural pomegranate juice.

12. Drink according to claim 8, wherein the basic liquid comprises at least one fruit juice concentrate.

13. Method of preparing a drink according to claim 8, comprising the step of:
a) mixing or infusing a composition comprising green coffee extract and yerba Mate extract in an edible basic liquid to obtain an edible drink.

14. Method according to claim 13 further comprising the step of pasteurising the mixture or infusion made in step a) of claim 13.

15. Method according to claim 13 further comprising the step of mixing at least one natural fruit juice with the composition.

16. Method according to claim 13 further comprising the step of mixing at least one fruit concentrate with the composition.

17. Edible composition comprising extract of green coffee and yerba mate extract.

18. A method of using a drink according to with an energising and stimulating effect on an individual comprising administering the drink of claim 8 to the individual.
